(19) United States
(12) Patent Application Publication
(10) Pub. No.: US 2005/0180726 A1
(43) Pub. Date: Aug. 18, 2005

(54) Coupled building wire with lubricant coating

(76) Inventors: John R. Carlson, Newnan, GA (US); Charles D. Mercier, Carrollton, GA (US); Mark D. Dixon, Carrollton, GA (US); Randy D. Kummer, Villa Rica, GA (US); John W. Armstrong, Villa Rica, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/056,492

(22) Filed: Feb. 11, 2005

Related U.S. Application Data
(60) Provisional application No. 60/544,294, filed on Feb. 12, 2004.

(51) Int. Cl. G02B 6/00

(52) U.S. Cl. 385/147

(57) ABSTRACT

A coupled building wire comprising a first length of non-metallic cable having a top surface and a bottom surface and a second length non-metallic cable having a top surface and a bottom surface, wherein the bottom surface of the first length of non-metallic cable is coupled to the top surface of the second length of non-metallic cable, and wherein at least the top surface of the first length of non-metallic cable and at least the bottom surface of the second length of non-metallic cable are at least partly covered with a lubricant coating. The first length of non-metallic cable comprises at least one circuit conductor having a first gauge. The second length of non-metallic cable comprises at least one circuit conductor having a second gauge. The first gauge of the at least one circuit conductor of the first length of non-metallic cable may be substantially equal or unequal to the second gauge of the at least one circuit conductor of the second length of non-metallic cable.

### RELATED APPLICATIONS

This application claims the benefit of priority of U.S. provisional application Ser. No. 60/544,294, filed Feb. 12, 2004, which is relied on and incorporated herein by reference.

### FIELD OF THE INVENTION

The present invention relates generally to electrical wire and cable. More specifically, the present invention relates to coupled building wire comprising more than one length of non-metallic sheathed cable, wherein the lengths of cable are coupled and covered with a lubricant coating so that an electrician can pull more than one length of cable into a structure at a time using less force than that required by conventional building wire.

### BACKGROUND OF THE INVENTION

Non-metallic (“NM”) sheathed cable is suitable for use in concealed or exposed, dry, protected areas (e.g., inside stud walls and on the sides of joists) and is commonly used to provide electrical power throughout homes built in the United States. NM cable is installed during the construction phase of a building, home, or other structure by pulling a length of cable from a coil into the structure and through openings or bores formed in the structure's internal framing elements, cutting the cable at its desired length, and connecting the cable to various components such as outlet boxes, junction boxes, switches, and fixtures.

Conventional NM cable is sold as a single unit, i.e., each coil contains one length of cable (a “circuit”) that has a uniform gauge or size. Consequently, when an electrician needs to install more than one circuit at once, he or she must pull each circuit from a separate coil. The use of multiple coils is a significant burden that requires extra set up time and often results in the undesirable entanglement of the two lengths of cable.

Because electricians frequently use more than one gauge of cable in the construction of a home, the burden of using multiple coils is commonly experienced. For example, in a typical home, each room has lighting elements that require one gauge of NM cable and electrical outlets that require a different gauge of NM cable. In particular, a 15-amp circuit used for lighting will employ a 14 American Wire Gauge (“AWG”) NM cable, but a 20-amp circuit used for electrical outlets will employ a 12 AWG NM cable. Thus, during construction, a length of 14 AWG NM cable and a length of 12 AWG NM cable will need to be pulled into each room, which conventionally requires the set up and use of more than one coil. As another example, a single room may need more than one dedicated 15-amp circuit, thereby requiring that more than one length of 14 AWG NM cable be pulled into the room. Here, as in the previous example, it would be preferable to be able to pull all of the necessary lengths of wire from a single coil to reduce the time needed to set up multiple coils and to eliminate the risk of entanglement.

Another disadvantage of conventional NM cable is that the exterior surface has a high coefficient of friction, making it difficult to pull over rafters, through studs, or around corners. The high level of force required to pull in conventional NM cables results in damage to the cable, such as tearing or rippling, and physical fatigue on the part of the installer.

Accordingly, a need therefore exists for a NM cable construction that allows an electrician to pull more than one length of cable into a structure at a time using less force than that required by conventional building wire.

### SUMMARY OF THE INVENTION

The present invention answers this need by providing a coupled building wire wherein more than one length of NM cable, having the same or different gauges, are coupled together and at least partly covered with a lubricant coating so that an electrician may easily and quickly pull more than one length of cable into a structure from a single coil.

More specifically, the present invention relates to a coupled building wire comprising a first length of NM cable having a top surface and a bottom surface, and a second length NM cable having a top surface and a bottom surface, wherein the bottom surface of the first length of NM cable is coupled to the top surface of the second length of NM cable, and wherein at least the top surface of the first length of non-metallic cable and at least the bottom surface of the second length of non-metallic cable are at least partly covered with a lubricant coating.

It is thus an advantage of the present invention to provide a coupled building wire having a surface with reduced coefficient of friction that permits more than one length of cable to be dispensed simultaneously without entanglement.

It is another advantage of the present invention to provide a coupled building wire having a surface with reduced coefficient of friction that permits an electrician to draw lengths of cable having different gauges simultaneously from a single coil and without entanglement.

It is yet another advantage of the present invention to provide a coupled building wire that substantially lowers the amount of force required to pull more than one length of cable into a structure.

It is still another advantage of the present invention to provide a coupled building wire that reduces the amount of damage caused to the wire by the installation process.

These and further advantages of the present invention will become apparent after a review of the following detailed description of the disclosed embodiments.

### BRIEF DESCRIPTION OF THE DRAWINGS

FIG. 1 is a cross sectional view of a length of non-metallic sheathed cable which may be used to construct the present invention.

FIG. 2 is a cross sectional view of a coupled building wire according to a first embodiment of the present invention.

FIG. 3 is a cross sectional view of a coupled building wire according to a second embodiment of the present invention.

FIG. 4 is a cross sectional view of a coupled building wire according to a third embodiment of the present invention.

FIG. 5 is a cross sectional view of a coupled building wire according to a fourth embodiment of the present invention.

### DETAILED DESCRIPTION OF THE INVENTION

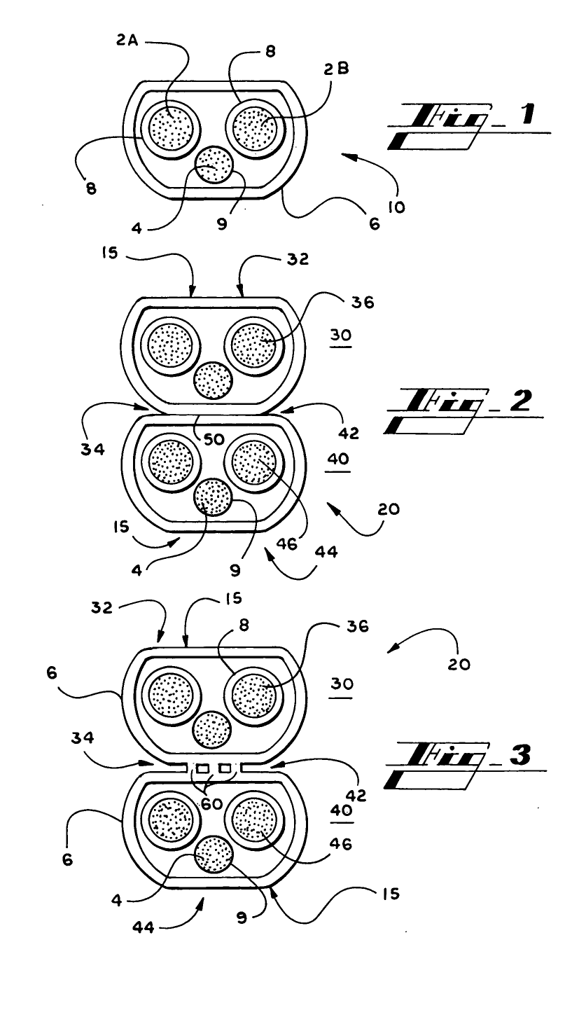

With reference to FIG. 1, a length of non-metallic (“NM”) sheathed cable 10 comprises two circuit conductors 2A and 2B, a grounding conductor 4, and an outer sheath 6. The two circuit conductors 2A and 2B and the grounding conductor 4 are generally constructed of copper or aluminum alloys and may be of sizes 14 American Wire Gauge (“AWG”) to 2 AWG. The outer sheath 6 is conventionally constructed of polyvinyl chloride (“PVC”). Each circuit conductor 2A and 2B is wrapped in insulation 8 that is conventionally constructed of PVC. The grounding conductor 4 may be wrapped in paper 9 to prevent contact with the outer sheath 6 and the insulation 8.

With reference to FIG. 2, the present invention provides a coupled building wire 20 comprising a first length of NM cable 30 having a top surface 32 and a bottom surface 34, a second length NM cable 40 having a top surface 42 and a bottom surface 44, wherein the bottom surface 34 of the first length of NM cable 30 is coupled to the top surface 42 of the second length of NM cable 40 and wherein at least the top surface 32 of the first length of NM cable 30 and at least the bottom surface 44 of the second length of NM cable 40 are at least partly covered with a lubricant coating 15. The first length of NM cable 30 comprises at least one circuit conductor 36 having a first gauge and the second length of NM cable 40 comprises at least one circuit conductor 46 having a second gauge. It will be appreciated that additional surfaces of the first length of NM cable 30 and/or the second length of NM cable 40 may be partly, substantially or completely covered with the lubricant coating 15, depending on the method with which the lubricant coating 15 is applied, as described in further detail below.

The lubricant coating 15 may be any suitable substance that provides a thin film on the surface of the coupled building wire 20 to enhance lubricity and lower the coefficient of friction. In one embodiment, the lubricant coating 15 comprises an external release agent manufactured by Axel Plastics Research Laboratories, Inc. and sold under the trade name MoldWiz™. According to this embodiment, the lubricant coating 15 may comprise an aqueous emulsion of resins and at least one surfactant in a water vehicle. Also according to this embodiment, the lubricant coating 15 may comprise an emulsion of organic esters, cross-linked polyolefins, fatty acids, and at least one surfactant in a water vehicle.

In another embodiment, the lubricant coating 15 comprises a water-and-isopropyl-alcohol-based dispersion manufactured by E. I. du Pont de Nemours and Company and sold under the trade name DryFilm WDL905. According to this embodiment, the lubricant coating 15 comprises water, at least one siloxane polymer, isopropyl alcohol, and poly-TFE, omega-hydro-alpha-(methylcyclohexyl).

In still other embodiments, the lubricant coating 15 is selected from the group consisting essentially of fatty amides, hydrocarbon oils, fluorinated organic resins, and mixtures thereof. Advantageous fatty amides and metallic fatty acids include, but are not limited to erucamide, oleamide, oleyl palmitamide, stearyl stearamide, stearamide, behenamide, ethylene bisstearamide, ethylene bisoleamide, stearyl erucamide, erucyl stearamide, and the like. Advantageous hydrocarbon oils include, but are not limited to, mineral oil, silicone oil, and the like. Lubricant coating 15 substances suitable for the present invention further include plasticizers, dibasic esters, silicones, anti-static amines, organic amines, ethanolamides, mono- and di-glyceride fatty amines, ethoxylated fatty amines, fatty acids, zinc stearate, stearic acids, palmitic acids, calcium stearate, lead stearate, sulfates such as zinc sulfate, and the like. The above lubricant coatings 15 may be used individually or in combination. Additional suitable lubricant coating 15 substances include fluorinated organic resins, such as a polymer of one or more fluorinated monomers selected from the group consisting essentially of tetrafluoroethylene, vinylidene fluoride, chlorotrifluoroethylene and the like. The fluorinated resin may be used in the form of a powder, emulsion or aqueous dispersion.

The lubricant coating 15 may be applied to the coupled building wire 20 by various methods, including, but not limited to, dipping the coupled wire 20, or the individual lengths of cable 30 and 40 prior to being coupled, into a container of the lubricant coating 15, spraying one or more surfaces of the coupled wire 20, or of the individual lengths of cable 30 and 40 prior to being coupled, with the lubricant coating 15 using a spray gun or the like, wiping or brushing the lubricant coating 15 onto one or more surfaces of the coupled wire 20, or of the individual lengths of cable 30 and 40 prior to being coupled, or depositing the lubricant coating 15 onto one or more surfaces of the coupled wire 20, or of the individual lengths of cable 30 and 40 prior to being coupled using a calibrated die or by plasma phase spraying.

According to one characteristic of the invention, the spraying step is carried out between the step of coating the circuit conductor 36 or 46 with plastic material and the step of cooling said material. This position of the spraying step in time is important since, when the circuit conductor 36 or 46 is coated with the plastic material, said material is in a state of fusion, the high temperature of which causes volatilization of the solvents present in the lubricant coating 15, which means that there is greater adherence of said lubricant coating 15 on the surface of the plastic material. The subsequent cooling of the plastic material together with the lubricant coating 15 leads to drying on the surface, leaving the two materials bonded to form a coating of low coefficient of friction.

The building wire 20 is characterized in that it may incorporates the lubricant coating 15 on the outer sheath 6 of the individual cables 30 and 40. If desired, the outer sheath of the cable 30 and/or 40 may be somewhat porous, thereby resulting in lubricant coating 15 residing in the pores. The outer sheath 6 on the cable 30 and/or 40 is thus well covered with said lubricant coating 15, forming a fine layer on the plastic material, since it emerges at high pressure and the plastic material is at high temperatures.

The equipment for the manufacturing of building wire 20 is characterized in that it includes a device for the application of the lubricant coating 15 on the surface of the cable 30 and/or 40. Said device may be a box section through which the cable 30 or 40 passes, a plurality of nozzles for spraying the lubricant coating 15 mounted inside the box section, a tank for said lubricant coating 15, and a pressure pump to carry the lubricant coating 15 from the tank to the spraying nozzles. Moreover, the device also includes a pressure adjusting valve, a level indicator for the tank containing the lubricant coating 15, and a pressure gauge.

In the depicted embodiment, the first gauge of the at least one circuit conductor 36 of the first length of NM cable 30 is substantially equal to the second gauge of the at least one circuit conductor 46 of the second length of NM cable 40. In other embodiments, the first gauge of the at least one circuit conductor 36 of the first length of NM cable 30 is unequal to the second gauge of the at least one circuit conductor 46 of the second length of NM cable 40.

With continuing reference to FIG. 2, in a first embodiment of the present invention, the bottom surface 34 of the first length of NM cable 30 is coupled to the top surface 42 of the second length of NM cable 40 using a cementitious material 50 and at least the top surface 32 of the first length of NM cable 30 and at least the bottom surface 44 of the second length of NM cable 40 are at least partly covered with a lubricant coating 15. In accordance with this embodiment, the cementitious material 50 is applied to either the bottom surface 34 of the first length of NM cable 30 or to the top surface 42 of the second length of NM cable 40. The bottom surface 34 of the first length of NM cable 30 and the top surface 42 of the second length of NM cable 40 are then pressed together to form the coupled building wire 20. It will be appreciated that the cementitious material 50 may be any suitable cement-like substance such as PVC cement or the like.

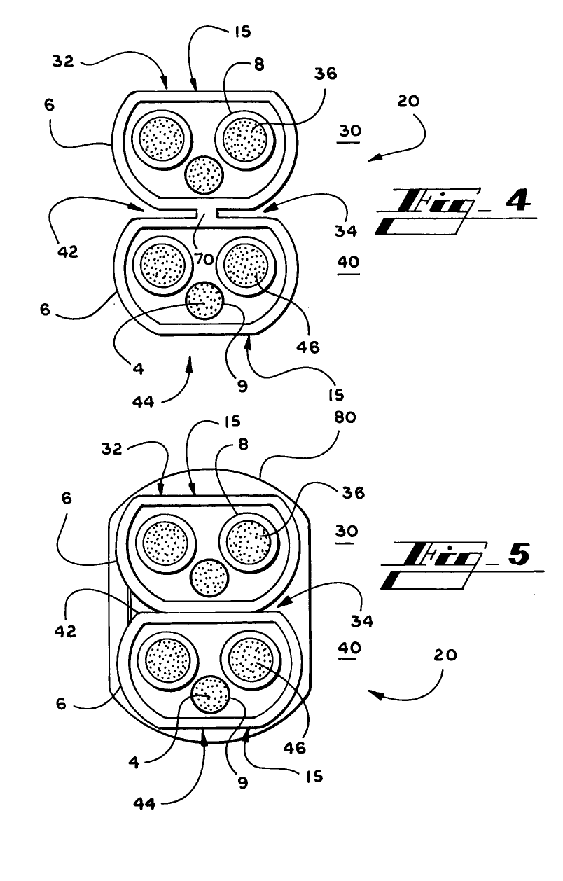

With reference to FIG. 3, in a second embodiment of the present invention, the bottom surface 34 of the first length of NM cable 30 is coupled to the top surface 42 of the second length of NM cable 40 using glue 60 and at least the top surface 32 of the first length of NM cable 30 and at least the bottom surface 44 of the second length of NM cable 40 are at least partly covered with a lubricant coating 15. In accordance with this embodiment, the glue 60 is applied to either the bottom surface 34 of the first length of NM cable 30 or to the top surface 42 of the second length of NM cable 40 as a non-continuous bead or as a continuous bead. The bottom surface 34 of the first length of NM cable 30 and the top surface 42 of the second length of NM cable 40 are then pressed together to form the coupled building wire 20. It will be appreciated that the glue 60 may be a soft glue or a hard glue.

With reference to FIG. 4, in a third embodiment of the present invention, the bottom surface 34 of the first length of NM cable 30 is coupled to the top surface 42 of the second length of NM cable 40 using a webbing material 70 and at least the top surface 32 of the first length of NM cable 30 and at least the bottom surface 44 of the second length of NM cable 40 are at least partly covered with a lubricant coating 15. In accordance with this embodiment, an extrusion machine is employed to apply the webbing material 70 to the bottom surface 34 of the first length of NM cable 30 and the top surface 42 of the second length of NM cable 40. The bottom surface 34 of the first length of NM cable 30 and the top surface 42 of the second length of NM cable 40 are then pressed together to form the coupled building wire 20. It will be appreciated that the webbing material 70 may be any suitable substance such as polypropylene webbing or the like.

With reference to FIG. 5, in a fourth embodiment of the present invention, the bottom surface 34 of the first length of NM cable 30 is coupled to the top surface 42 of the second length of NM cable 40 using heat shrinkable insulation 80 and at least the top surface 32 of the first length of NM cable 30 and at least the bottom surface 44 of the second length of NM cable 40 are at least partly covered with a lubricant coating 15. In accordance with this embodiment, the first length of NM cable 30 and the second length of NM cable 40 are wrapped together using a material constructed of PVC or polyolefin that, when subjected to an elevated temperature, draws in tightly around the cables 30 and 40. The heat shrinkable insulation 80 may be transparent for allowing visibility of the cables 30 and 40 and the circuit conductors 36 and 46, thereby providing electricians with the ability to distinguish such elements based on color. In still another embodiment, the first length of NM cable 30 and the second length of NM cable 40 are held together using a overall jacket, or tube.

In another embodiment of the present invention, the bottom surface 34 of the first length of NM cable 30 is coupled to the top surface 42 of the second length of NM cable 40 using at least two complementary strips of Velcro®-like material, i.e., material having complementary parts which adhere to each other when pressed together and adapted for use as a fastener and at least the top surface 32 of the first length of NM cable 30 and at least the bottom surface 44 of the second length of NM cable 40 are at least partly covered with a lubricant coating 15. In accordance with this embodiment, at least one strip of Velcro®-like material is placed along the bottom surface 34 of the first length of NM cable and at least one complementary strip of Velcro®-like material is placed along the top surface of the second length of NM cable. The bottom surface 34 of the first length of NM cable 30 and the top surface 42 of the second length of NM cable 40 are then pressed together to adhere the complementary parts of the Velcro®-like material to each other to form the coupled building wire 20.

In a further embodiment of the present invention, the bottom surface 34 of the first length of NM cable 30 is coupled to the top surface 42 of the second length of NM cable 40 using a self-locking threaded fastener and at least the top surface 32 of the first length of NM cable 30 and at least the bottom surface 44 of the second length of NM cable 40 are at least partly covered with a lubricant coating 15. In accordance with this embodiment, a self-locking threaded fastener, such as that commonly known by the trademark ZIPLOC, is attached to the bottom surface 34 of the first length of NM cable 30 and to the top surface 42 of the second length of NM cable 40. The bottom surface 34 of the first length of NM cable 30 and the top surface 42 of the second length of NM cable 40 are then pressed together to lock the self-locking fastener and form the coupled building wire 20. It will be appreciated that the self-locking fastener could be attached during assembly of the coupled building wire 20 or formed into the outer sheath 6 of the first 30 and second 40 lengths of cable by incorporating the self-locking fastener into extrusion tooling.

In still further embodiments of the present invention, the bottom surface 34 of the first length of NM cable 30 is coupled to the top surface 42 of the second length of NM cable 40 using any other suitable adhesive material or other means, such as double-sided tape, an adhesive polymeric strip, a binding strip (constructed of mylar, polyester, string or the like), welding (such as hot air welding, ultrasonic welding, solvent bonding or the like), or any combination of the above and at least the top surface 32 of the first length of NM cable 30 and at least the bottom surface 44 of the second length of NM cable 40 are at least partly covered with a lubricant coating 15.

It will be appreciated that each of the aforementioned embodiments allow for easy separation of the first length of NM cable 30 from the second length of NM cable 40 once the coupled building wire 20 has been pulled into the building or home that is under construction. Further, the preferred bonded embodiments offer an inherent tangle-resistance feature thereby reducing and possibly eliminating the problems of multiple cables tangling up during installation. Because the tangling of NM cable is a result of the wire conductors' “radii memory,” i.e., the tendency to remain coiled and resist straightening, the present invention eliminates any competing radii memory by providing more than one circuit in the same package and stored with the same radius.

By having a lubricant coating 15 applied to the surface of the coupled building wire 20, the present invention provides coupled wire that has a lower coefficient of friction than conventional building wire. This makes the wire easier to install because it slips on the surfaces with which it comes into contact. More particularly, the present invention provides a coupled building wire 20 that requires significantly less force to pull through a given structure than conventional wire, thereby reducing the installer's level of fatigue, requiring fewer climbs up ladders during installation, and allowing longer pulls of cable during installation. Accordingly, the overall time needed to install the building wire is reduced.

Another beneficial property gained by the present invention is an increased resistance to “burn-through.” “Burn-through,” or “pull-by,” results from friction generated by pulling one cable over various structures or over another cable during installation, causing deterioration and eventual destruction to the outer sheath of the cable(s). When using a lubricated cable in accordance with the present invention, the occurrence of burn-through is reduced.

The present inventive cable may also enhance the ease with which the outer sheath may be stripped from the cable end.

A further benefit of the present invention is the reduction of outer sheath rippling. Outer sheath rippling results from the friction of the outer sheath against building materials, causing the outer sheath material to stretch and bunch. Damage to the outer sheath may result. Lubricating the coupled building wire in accordance with the present invention prevents outer sheath rippling from occurring.

Having thus described the invention in detail, it should be apparent that various modifications and changes may be made without departing from the spirit and scope of the present invention. Consequently, these and other modifications are contemplated to be within the spirit and scope of the following claims.

1. A coupled building wire comprising:
a first length of non-metallic cable having a top surface and a bottom surface; and
a second length non-metallic cable having a top surface and a bottom surface;
wherein the bottom surface of the first length of non-metallic cable is coupled to the top surface of the second length of non-metallic cable; and wherein at least the top surface of the first length of non-metallic cable and at least the bottom surface of the second length of non-metallic cable are at least partly covered with a lubricant coating.

2. A coupled building wire as defined in claim 1 wherein the lubricant coating comprises an aqueous emulsion of resins.

3. A coupled building wire as defined in claim 1 wherein the lubricant coating includes at least one surfactant.

4. A coupled building wire as defined in claim 1 wherein the lubricant coating is an emulsion containing a material selected from the group consisting essentially of organic esters, cross-linked polyolefins, fatty acids; and mixtures thereof.

5. A coupled building wire as defined in claim 1 wherein the lubricant coating comprises water; at least one siloxane polymer, and isopropyl alcohol.

6. A coupled building wire as defined in claim 1 wherein the first length of non-metallic cable comprises at least one circuit conductor having a first gauge and the second length of non-metallic cable comprises at least one circuit conductor having a second gauge, and wherein the first gauge of the at least one circuit conductor of the first length of non-metallic cable is substantially equal to the second gauge of the at least one circuit conductor of the second length of non-metallic cable.

7. A coupled building wire as defined in claim 1 wherein the first length of non-metallic cable comprises at least one circuit conductor having a first gauge and the second length of non-metallic cable comprises at least one circuit conductor having a second gauge, and wherein the first gauge of the at least one circuit conductor of the first length of non-metallic cable is unequal to the second gauge of the at least one circuit conductor of the second length of non-metallic cable.

8. A coupled building wire as defined in claim 1 wherein the bottom surface of the first length of non-metallic cable is coupled to the top surface of the second length of non-metallic cable by materials selected from the group consisting essentially of cementatious material, glue, webbing material, heat-shrinkable material, material having complimentary parts which adhere to each other when pressed together, self-locking threaded fasteners, adhesive material, double-sided tape, adhesive polymeric strip, binding strip, welding, and combinations thereof.

9. A coupled building wire as defined in claim 8 wherein the lubricant coating comprises an aqueous emulsion of resins.

10. A coupled building wire as defined in claim 8 wherein the lubricant coating includes at least one surfactant.

11. A coupled building wire as defined in claim 8 wherein the lubricant coating is an emulsion containing a material selected from the group consisting essentially of organic esters, cross-linked polyolefins, fatty acids, and mixtures thereof.

12. A coupled building wire as defined in claim 8 wherein the lubricant coating comprises water; at least one siloxane polymer, and isopropyl alcohol.

13. A coupled building wire as defined in claim 8 wherein the binding strip is constructed of materials selected from the group consisting essentially of mylar, polyester, string, and combinations thereof.

14. A coupled building wire as defined in claim 8 wherein the welding is selected from the group consisting essentially of hot-air welding, ultrasonic welding, solvent welding, and combinations thereof.
